(19) United States
(12) Patent Application Publication
(10) Pub. No.: US 2026/0069075 A1
(43) Pub. Date: Mar. 12, 2026

(54) SYSTEM AND METHOD OF POWERING AND COMMUNICATING WITH ACCESSORIES

(71) Applicant: BREVILLE PTY LIMITED, Alexandria, New South Wales (AU)

(72) Inventors: Lochana Subasekara WIDANAGAMAGE DON, Alexandria, New South Wales (AU); Con PSAROLOGOS, Alexandria, New South Wales (AU); Xiang REN, Alexandria, New South Wales (AU); Duncan Bruce HELLMERS, Lane Cove (AU)

(21) Appl. No.: 18/872,189

(22) PCT Filed: Jun. 13, 2023
(86) PCT No.: PCT/AU2023/050521

§ 371 Date: Dec. 5, 2024

(30) Foreign Application Priority Data
Jun. 14, 2022 (AU) 2022901611

(51) Int. Cl. A47J 27/21; A47J 31/52; A47J 31/56

(52) U.S. Cl. CPC A47J 27/21091; A47J 27/2105; A47J 31/5253; A47J 31/5255; A47J 31/56

(57) ABSTRACT

A system configured to allow a kitchen device to power and communicate with an associated accessory, the system comprising a first coil located in the kitchen device; a second coil, at least one sensor and a controller located in the accessory, the at least one sensor and controller being connected to the second coil, wherein, when the first and second coils are inductively coupled, the controller is configured to receive data from the at least one sensor, the data relating to a physical attribute, and transmit the data to the first coil via the second coil, and wherein the second coil is configured to receive electrical power from the first coil.

### FIELD

This invention relates to a system and method of powering and communicating with accessories associated with a device.

### BACKGROUND

Kitchen devices often have a removable accessory that is used in combination with the kitchen device to perform various functions of the kitchen device, for example, a coffee machine and its associated portafilter and milk jug. As these accessories are not electrically connected to the kitchen device by wires, there are technical limitations on obtaining data from and powering the sensors located in the accessory. Accessing data from sensors located in the accessory is beneficial as it can assist with optimizing the operation of the kitchen device with real time measurements taken while the device is operating.

To obtain data regarding temperature or other physical attributes, some devices have accessories with wired sensors, with the sensor or the accessory connected to the device by a wire to provide power to the sensor and to receive data from the sensor. However, such a setup is undesirable as it tethers the accessory to the device and allows limited range for use of the accessory. Further, having an external wire connecting the device and its associated accessory would impede use of the accessory and such a visible and prominent wire may be unsafe and aesthetically unpleasant.

### SUMMARY

It is an object of the present invention to at least substantially address one or more of the disadvantages or problems described above, or at least provide a useful alternative.

In a first aspect, although not necessarily the only or broadest form, the invention resides in a system configured to allow a kitchen device to power and communicate with an associated accessory, the system comprising:
a first coil located in the kitchen device;
a second coil, at least one sensor and a controller located in the accessory, the at least one sensor and controller being connected to the second coil,
wherein, when the first and second coils are inductively coupled, the controller is configured to:
   receive data from the at least one sensor, the data relating to a physical attribute, and
   transmit the data to the first coil via the second coil, and
wherein the second coil is configured to receive electrical power from the first coil.

Preferably, the kitchen device is a coffee machine. Preferably, the accessory is a jug associated with the coffee machine. Preferably, the accessory comprises a bottom wall and a side wall extending upwardly from the bottom wall.

Preferably, the first coil is configured to wirelessly power and communicate with the second coil by inducing electric current or electric potential in the second coil. Preferably, the first coil is located in a portion of the kitchen device that is adjacent an aerating member of the kitchen device. Preferably, the aerating member is a steam wand.

Preferably, the kitchen device includes a first controller electrically connected to the first coil. Preferably, the first controller is configured to provide power to and communicate with the first coil.

Preferably, the kitchen device includes a second controller electrically connected to the first controller and the first coil. Preferably, the second controller is configured to control temperature and air flow rate of steam emitted through the steam wand.

Preferably, the second coil and the controller of the accessory are attached to the bottom wall of the accessory.

Preferably, the at least one sensor is electrically connected to the controller of the accessory. Preferably, the at least one sensor is a temperature sensor. Preferably, the at least one sensor is a NTC thermistor. Preferably, the at least one sensor is configured to measure a physical attribute of fluid in the accessory. Preferably, the physical attribute measured by the at least one sensor is a temperature of the fluid. Preferably, the physical attribute measured by the at least one sensor is density or turbidity of the fluid. Preferably, the accessory includes a further sensor that is configured to measure a further physical attribute of the fluid in the accessory.

Preferably, the controller of the accessory includes a DC power regulator and a microprocessor electrically connected to the DC power regulator. Preferably, the DC power regulator receives the electrical power from the second coil. Preferably, the DC power regulator converts the AC electrical power into DC power which is used to power the microprocessor.

Preferably, the controller receives and encodes the data from the at least one sensor. Preferably, a microprocessor of the controller encodes the data. Preferably, the data from the at least one sensor is encoded in amplitude shift keying (ASK). Preferably, the controller of the accessory converts the data from the at least one sensor into a binary code format. Preferably, the data from the at least one sensor is encoded in amplitude shift keying (ASK) by the microprocessor.

Preferably, the first controller of the kitchen device includes an ASK filter, a microprocessor and a carrier frequency generator electrically connected to each other. Preferably, the first controller decodes the data from the at least one sensor that is received by the first coil. Preferably, the ASK filter of the first controller decodes the data. Preferably, the data from the at least one sensor is decoded by a FSK (frequency shift keying) filter of the first controller.

Preferably, the microprocessor of the first controller receives the data from the at least one sensor and issues control commands to control operation of the kitchen device. Preferable, the microprocessor of the first controller receives the data from the at least one sensor and issues control commands to control operation of the aerating member via the second controller.

Preferably, the accessory is a filter associated with the coffee machine. Preferably, the filter is a portafilter configured to hold ground coffee. Preferably, the accessory comprises a handle and a basket portion connected to the handle.

Preferably, the kitchen device includes a heater configured to heat water. Preferably, the first coil is located in a portion of the kitchen device that is adjacent a region where the filter is likely to be used and connected to the coffee machine.

Preferably, the second controller is configured to control a temperature and flow rate of water being used to extract coffee. Preferably, the second controller is configured to control a duration of flow of water or the pressure of the water.

Preferably, the second coil and the controller of the accessory are housed in the handle of the accessory.

Preferably, the physical attribute measured by the at least one sensor is viscosity, flow rate and/or pH of the fluid.

Preferably, the microprocessor of the first controller receives the data from the at least one sensor and issues control commands to display information to a user, the information relating to the data from the at least one sensor. Preferably, the microprocessor of the first controller receives the data from the at least one sensor and issues control commands to the heater via the second controller.

Preferably, the accessory includes an identifier located therein. Preferably, the identifier is a magnet, RFID or NFC tag. Preferably, the identifier allows the accessory to be identified by the kitchen device. Preferably, the identifier is configured to be powered by the electrical power received by the second coil from the first coil.

Preferably, the accessory includes a power storage device. Preferably, the power storage device is a supercapacitor, ultracapacitor or a battery. Preferably, the power storage device is configured to store power when the electrical power is received by the second coil from the first coil. Preferably, the power storage device allows the controller of the accessory and the at least one sensor to be powered by the power stored in the power storage device. Preferably, the power storage device powers a display on the accessory.

Preferably, the system includes a radio frequency (RF) or Bluetooth (BT) module to transmit and/or receive the data from the at least one sensor. Preferably, the RF module is a low power RF module. Preferably, the BT module is a Bluetooth low energy (BLE) module. Preferably, the RF or BT module is located in the accessory and powered by the electrical power received by the second coil. Preferably, the RF or BT module receives the data from the at least one sensor and transmits the data to a further RF or BT module located in the kitchen device.

Preferably, the kitchen device is a heater base. Preferably, the accessory is a vessel associated with the heater base. Preferably, the kitchen device and the accessory collectively function as an induction kettle. Preferably, the vessel holds water or other liquid to be heated.

Preferably, the kitchen device is connected to a power supply that is electrically coupled to an induction coil housed within the kitchen device. Preferably, the induction coil is magnetically coupled to a heating element located in the accessory when the accessory is resting on the kitchen device. Preferably, the induction coil is configured to deliver a magnetic field to the heating element for heating the water contained in the accessory. Preferably, the heating element is a heating disc or plate

Preferably, the second controller of the kitchen device is configured to control the induction coil to heat the water in the accessory. Preferably, the first coil and the induction coil are offset from each other and operate at different frequencies.

Preferably, the second coil is located at a lower end of the accessory and the controller of the accessory is located at an opposite upper end thereof. Preferably, a shaft extends centrally through the accessory. Preferably, the shaft is located between the controller and the second coil. Preferably, an upper end of the shaft is connected to the controller and a lower end of the shaft is connected to the second coil.

Preferably the shaft includes a plurality of sensors configured to measure a physical parameter or a physical parameter gradient. Preferably, the plurality of sensors are water level sensors. Preferably, the plurality of sensors are spaced from each other. Preferably, the plurality of sensors determine a height of the water level in the accessory and transmit data to the controller. Preferably, the plurality of sensors detect presence of scale in the accessory.

Preferably, the at least one sensor includes a first sensor and a second sensor. Preferably, the first sensor and second sensors are temperature sensors. Preferably, the first sensor is located at the lower end of the shaft. Preferably, second sensor is located adjacent the second coil. Preferably, the first sensor and second sensors are located at a distance from the heating element.

Preferably, the at least one sensor includes a third sensor. Preferably, the third sensor is a temperature sensor embedded in or mounted on to the heating element. Preferably, the third sensor measures a temperature of the heating element.

In a second aspect, the invention resides in a kitchen device configured to power and communicate with an associated accessory, the kitchen device comprising:
a first coil configured to be inductively coupled with a second coil located in the accessory and to transmit electrical power to the second coil,
wherein, when the first and second coils are inductively coupled, the first coil is configured to receive data from at least one sensor located in the accessory via the second coil, the data relating to a physical attribute.

In a third aspect, the invention resides in an accessory configured to be powered by and communicate with an associated kitchen device, the accessory comprising:
a second coil, at least one sensor and a controller located in the accessory, the at least one sensor and controller being connected to the second coil,
wherein the second coil is configured to receive electrical power from a first coil located in the kitchen device, and
wherein, when the first and second coils are inductively coupled, the controller is configured to:
   receive data from the at least one sensor, the data relating to a physical attribute, and
   transmit the data to the first coil via the second coil.

In a fourth aspect, the invention resides in a method of powering and communicating with an accessory associated with a kitchen device, the method comprising:
locating a second coil of the accessory adjacent a first coil of the kitchen device to inductively couple the first and second coils;
transmitting electrical power from the first coil to the second coil;
receiving, by a controller of the accessory, data from at least one sensor located in the accessory, the data relating to a physical attribute;
transmitting, by the controller, the data to the first coil via the second coil.

Preferably, transmitting electrical power from the first coil to the second coil includes:
generating, by the first coil, a signal at a predetermined frequency;
generating, by the second coil, the electrical power from the signal.

Preferably, transmitting, by the controller, the data to the first coil via the second coil includes:
encoding, by the controller, the data from the at least one sensor;
transmitting the encoded data to the first coil;
decoding, by a first controller of the kitchen device, the encoded data.

Preferably, when a second coil of the accessory is located adjacent a first coil of the kitchen device, an induction coil of the kitchen device is magnetically coupled with a heating element of the accessory.

In a fifth aspect, the invention resides in a method of operating a kitchen device and an associated accessory, the method comprising:
locating the accessory adjacent the kitchen device to inductively couple a first coil of the kitchen device and a second coil of the accessory;
transmitting, to the first coil via the second coil, data from at least one sensor located in the accessory, the data relating to a physical attribute;
determining a water level in the accessory and, when the data indicates that there is no water in the accessory, powering down the kitchen device, or, when the data indicates that the accessory contains water, heating the water by powering up an induction coil of the kitchen device.

Preferably, the method further includes:
monitoring a temperature of the water by the at least one sensor;
powering down the kitchen device if the temperature of the water has reached a temperature set by a user or if there is no change in the temperature of the water beyond a pre-determined temperature.

Preferably, the method further includes detecting “dry boil” by determining when a temperature sensed by the at least sensor is greater than a cut-off temperature and powering down the kitchen device.

Preferably, for detecting “dry boil”, the cut-off temperature T₁ is calculated as per the following formula:

$${T}_{1} = C - ( a * ( \frac{dT}{d t} ) ) - ( b * {T}_{s} )$$

where C is the maximum cut-off temperature for the accessory, dT/dt is a rate of change of temperature of the heating element, Tₛ is an initial temperature of the heating element prior to being heated and ‘a’ and ‘b’ are predetermined constants.

Preferably, the method further includes:
detecting a difference in a rate of change in temperature of two adjacent sensors of the at least one sensor
detecting a difference in temperature of the two adjacent sensors;
in response to determining that the rate of change in temperature of the two adjacent sensors exceeds a first predetermined limit or the difference in temperature of the two adjacent sensors exceeds a second predetermined limit, determining that one of the two adjacent sensors is faulty and powering down the kitchen device.

### BRIEF DESCRIPTION OF THE DRAWING

Preferred embodiments of the present invention will now be described by way of example, with reference to the accompanying drawings, wherein:

FIG. 1 is a schematic system diagram of a system of powering and communicating with accessories where the accessory is a jug associated with a coffee machine, according to an embodiment of the invention.

FIG. 2 is a schematic system diagram of the system of FIG. 1.

FIG. 3 is a schematic system diagram of a system of powering and communicating with accessories where the accessory is a portafilter associated with a coffee machine, according to a further embodiment of the invention.

FIG. 4 is a schematic system diagram of a system of powering and communicating with accessories where the accessory is a jug associated with a coffee machine, according to a further embodiment of the invention.

FIG. 5 is a schematic system diagram of a system of powering and communicating with accessories where the accessory is a portafilter associated with a coffee machine, according to a further embodiment of the invention.

FIG. 6 is a schematic system diagram of a system of powering and communicating with accessories where the accessory is a portafilter associated with a coffee machine, according to a further embodiment of the invention.

FIG. 7 is a schematic system diagram of a system of powering and communicating with accessories where the accessory is an induction kettle vessel associated with a base, according to a further embodiment of the invention

FIG. 8 is a schematic system diagram of the operation of the system of FIG. 7.

FIG. 9 is a further schematic system diagram of the operation of the system of FIG. 7.

### DETAILED DESCRIPTION

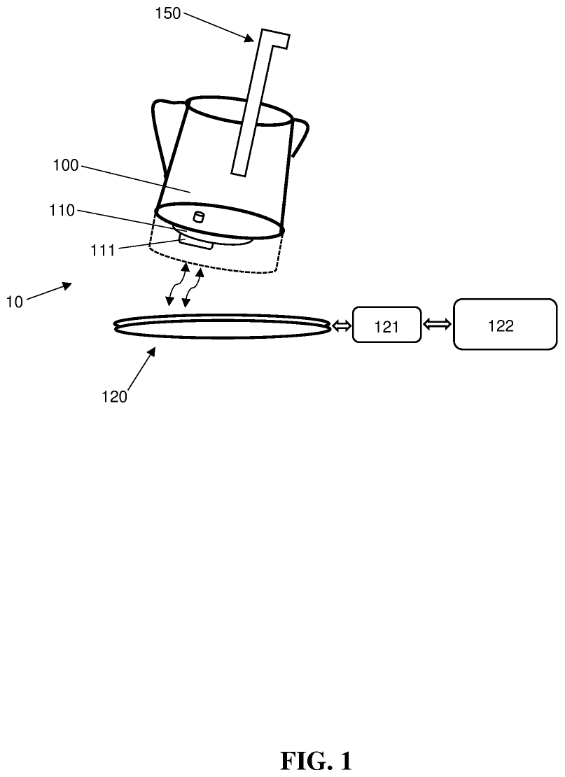

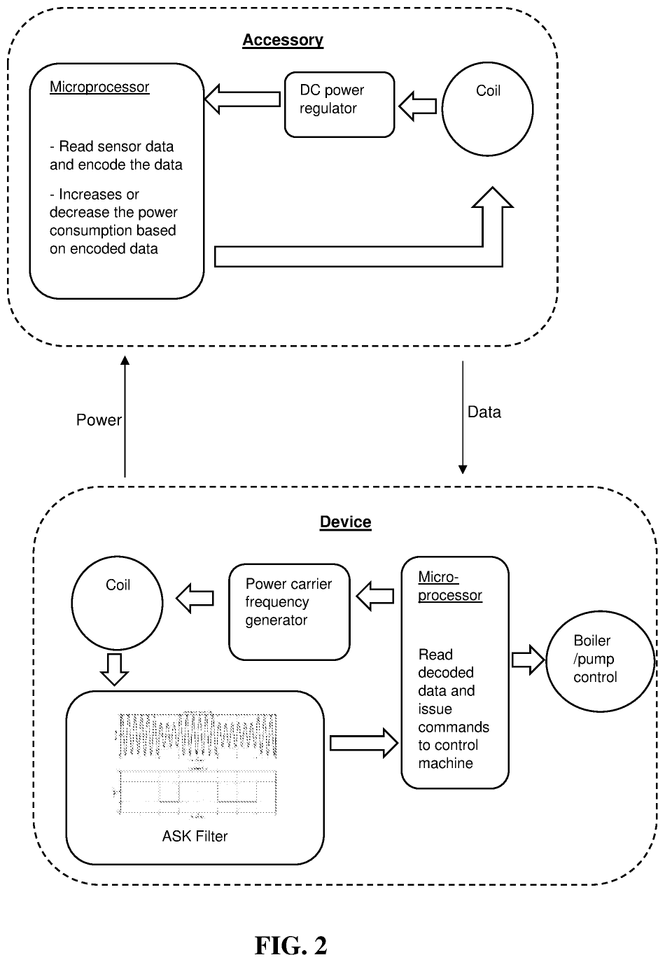

FIGS. 1 and 2 illustrate a system 10 of powering and communicating with accessories configured to allow a kitchen device to power and communicate with an accessory associated with the kitchen device. In this embodiment, the kitchen device is a coffee machine (not shown) and the accessory is a fluid container in the form of a jug 100 for heating and aerating/frothing milk or a milk alternative. The jug 100 comprises a bottom wall and a side wall extending upwardly from the bottom wall, thereby forming a space to receive the milk.

The coffee machine (not shown) includes a first coil 120, a first controller 121 and a second controller 122 electrically connected to each other. The first coil 120 is configured to wirelessly power and communicate with a second coil 110 located in the jug 100, for example by inducing electric current or electric potential in each other, and is located in a portion of the coffee machine that is adjacent the aerating member (in the form of a steam wand 150), i.e. adjacent the region where the jug 100 is likely to be used with the steam wand 150 to aerate/froth the milk. The first controller 121 is configured to provide power and communicate with the first coil 120 and to also communicate with the second controller 122. In this embodiment, the second controller 122 is configured to control the temperature and air flow rate of the steam emitted through the steam wand 150. However, in further embodiments, the second controller 122 may control other operation parameters of the coffee machine, for example, duration of a particular process, temperature of water, operating pressure etc and/or the second controller 122 may control a display located on the coffee machine.

Throughout the specification the term “electrical connection”, “connected” or “electrically connected” does not necessarily define a direct connection, but can also refer to an indirect connection, e.g. with a further electrical component, such as a resistor, located between the two points being connected, or it may also refer to being communicatively coupled.

Attached to the bottom wall of the jug 100 is the second coil 110 and a controller 111 electrically connected to the second coil 110. The controller 111 is also electrically connected to a sensor (not shown) located in the accessory. In this embodiment, the sensor is a temperature sensor in the form of a NTC thermistor that measures the temperature of the milk (or any other fluid) in the jug 100. However, in further embodiments, the sensor may measure other physical attributes, for example, density, turbidity, type of milk, froth level etc. and/or the jug 100 may include two or more sensors to measure several physical attributes. Moreover, in further embodiments, the second coil 110 and the controller 111 may be located elsewhere on the jug 100, the location being selected based on the location of the first coil 120. The second coil 110 is configured to communicate with and receive electrical power from the first coil 120.

In use, when the jug 100 is located substantially adjacent the first coil 120 of the coffee machine, the first coil 120 of the coffee machine and the second coil 110 of the jug 100 are inductively coupled and the second coil 110 receives electrical power from the first coil 120. As seen in FIG. 2, the controller 111 of the jug 100 includes a DC power regulator and a microprocessor electrically connected to the DC power regulator. The first coil 120 of the coffee machine generates a signal at a predetermined frequency, for example 100 kHz. The second coil 110 of the jug 100 is tuned to resonate at the same predetermined frequency and generates electrical power from the received signal. The DC power regulator receives the electrical power and converts it into DC power, which is then used to power the microprocessor. The data from the sensor is received and encoded in amplitude shift keying (ASK) by the microprocessor to transfer to the first coil 120 via the second coil 110. In particular, to transfer the data, the controller 111 of the jug 100 varies the power consumption of the circuitry in the accessory to generate a specific pulse pattern form. For example, the controller 111 may include a very low resistance resistor (which draws a very high current) and then switch off that resistor to generate a pattern of pulses. In this manner, the controller 111 of the jug 100 may convert data from the sensor into a binary code format.

The first controller 121 of the coffee machine includes an ASK filter, a microprocessor and a carrier frequency generator electrically connected to each other. The encoded data, received by the first coil 120 of the coffee machine, is decoded by the ASK filter and received by the microprocessor connected to it. However, in further embodiments, the data from the sensor may be encoded by the microprocessor 386 in frequency shift keying (FSK) and decoded by a FSK filter included in the first controller 121.

The microprocessor of the first controller 121 uses the decoded data and issues control commands to other components of the coffee machine to display key information to the user and/or to control operation of the steam wand 150 via the second controller 122. For example, based on the temperature data in the decoded data, the coffee machine may provide an indication to the user that the milk is ready and may automatically turn off the steam wand 150 or the entire coffee machine. Moreover, if the decoded data includes other physical attributes such as viscosity or data relating to the foam layer, this information may be provided to the user (via a display located on the coffee machine or via an app on the user's mobile device) and/or further operation of the coffee machine may be controlled based on such data (e.g. turning off the steam wand 150 or varying its operating parameters).

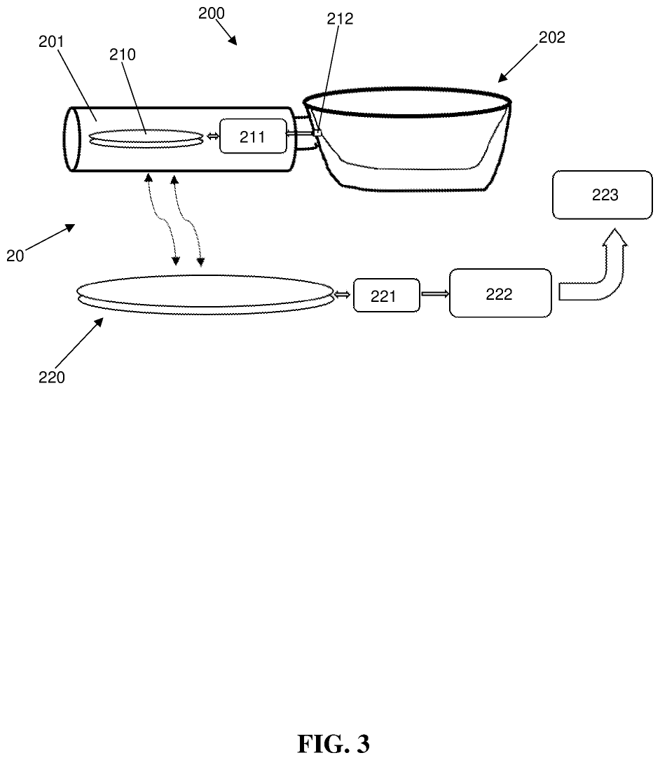

FIG. 3 illustrates a system 20 of powering and communicating with accessories, according to a further embodiment of the invention. The system 20 is configured to allow a kitchen device to power and communicate with an accessory associated with the kitchen device. In this embodiment, the kitchen device is a coffee machine (not shown) and the accessory is a filter in the form of a portafilter 200 that holds the ground coffee during extraction and through which the extracted coffee flows. The portafilter 200 comprises a handle 201 and a basket portion 202 connected to the handle 201.

Similar to the coffee machine of the system 10, the coffee machine of the system 20 includes a first coil 220, a first controller 221 and a second controller 222 electrically connected to each other. The coffee machine of the system 20 further includes a heater 223 that heats the water that is used to extract the coffee, the heater 223 being electrically connected to the first and second controllers 221, 222. The first coil 220 is configured to wirelessly power and communicate with a second coil 210 located in the portafilter 200, for example by inducing electric current or electric potential in each other, and is located in a portion of the coffee machine that is adjacent the region where the portafilter 200 is likely to be used and connected to the coffee machine. The first controller 221 is configured to provide power and communicate with the first coil 220 and to also communicate with the second controller 222. In this embodiment, the second controller 222 is configured to control the temperature and flow rate of the water being used to extract coffee. However, in further embodiments, the second controller 222 may control other operation parameters of the coffee machine, for example, duration of flow, operating pressure etc and/or the second controller 222 may perform calculations, generate recommendations and/or display relevant parameters (via a display) in real-time or after a predetermined amount of coffee has been extracted.

Housed in the handle 201 of the portafilter 200 is the second coil 210 and a controller 211 electrically connected to the second coil 210. The controller 211 is also electrically connected to a sensor 212 located in the portafilter 200. In this embodiment, the sensor is a temperature sensor in the form of a NTC thermistor that measures the temperature of the extracted coffee passing through the basket portion 202 of the portafilter 200. However, in further embodiments, the sensor 212 may measure other physical attributes, for example, viscosity, flow rate, pH etc. and/or the portafilter 200 may include two or more sensors to measure several physical attributes. The second coil 210 is configured to communicate with and receive electrical power from the first coil 220.

In use, the system 20 operates similar to the system 10, i.e. as shown in FIG. 2. When the portafilter 200 is located adjacent the first coil 220 of the coffee machine, the first coil 220 of the coffee machine and the second coil 210 of the portafilter 200 are inductively coupled and the second coil 210 receives electrical power from the first coil 220.

However, instead of controlling operation of the steam wand 150, in the system 20, the microprocessor of the first controller 221 uses the decoded sensor data and issues control commands to other components of the coffee machine to display key information to the user and/or to control operation of the heater 223 via the second controller 222. For example, based on the temperature data in the decoded data, the coffee machine may provide an indication to the user that the water being used for coffee extraction is too hot or not sufficiently warm and may automatically alter the operation of the heater 223. As a further example, the temperature data in the decoded data may allow the coffee machine to determine if the temperature gradient in the coffee puck (i.e. the ground coffee in the portafilter 200) is achieved relatively quickly, thereby indicating that the ground coffee is too fine, and the coffee machine may display this information and/or a recommendation to the user. Moreover, if the decoded data includes other physical attributes such as flow rate or water pressure, this information may be provided to the user (via a display located on the coffee machine or via an app on the user's mobile device) and/or further operation of the coffee machine may be controlled based on such data (e.g. turning off the heater 223 or varying its operating parameters).

In a further embodiment, the system 10 or the system 20 may include an identifier located in the accessory, for example, a magnet, RFID, NFC tag etc., to allow the accessory (the jug 100 or the portafilter 200) to be identified by the kitchen device (the coffee machine). Each accessory has a unique identifier and the identifier can be powered by the power received by the second coil 110, 210 from the first coil 120, 220. In this manner, the coffee machine can identify the type of jug 100 or portafilter 200 being used and may alter its operation based on the accessory being used.

The systems 10, 20 are entirely sealed, compact and allows transfer of data and power wirelessly between the kitchen device and the accessory. The sensors located in the accessories allow for critical data relating temperature, pressure, flow rate etc. to be read and transmitted to the kitchen device, which allows the device to control and/or alter its operation for optimum results. Moreover, the sensor being located inside the accessory allows for more accurate measurements, thereby enabling precise control for the desired results.

In the systems 10, 20, the transmission of power and communication of data between the first coil 120, 220 and the second coil 110, 210 has a limited range and is not possible when the second coil 110, 210 is located beyond a predetermined maximum distance from the first 120, 220, i.e. when the accessory is located beyond the predetermined maximum distance from the kitchen device, the maximum distance being dependent on the amount of power to be transmitted, amongst other factors.

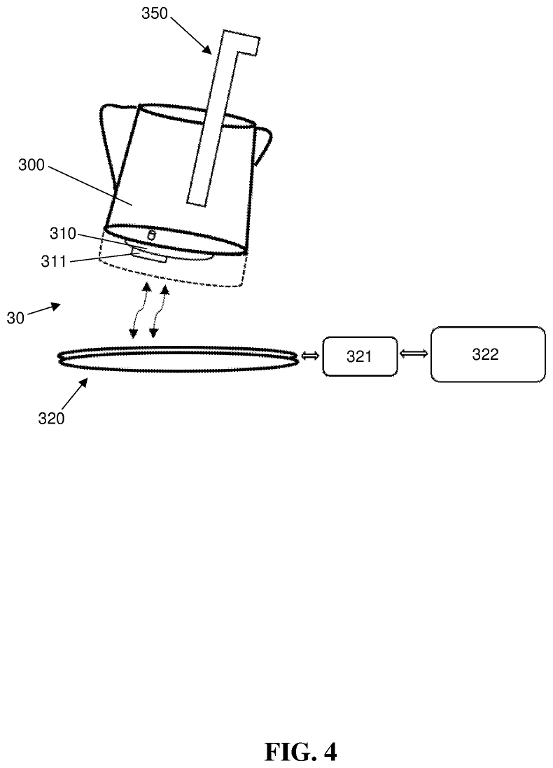

FIG. 4 illustrates a system 30 of powering and communicating with accessories, according to a further embodiment of the invention. The system 30 is configured to allow a kitchen device to power and communicate with an accessory associated with the kitchen device. The system 30 is similar to the system 10 but differences therebetween are noted below.

Like the system 10, the coffee machine of the system 30 includes a first coil 320, a first controller 321 and a second controller 322 electrically connected to each other. The jug 300 of the system 30 includes a second coil 310, a controller 311 electrically connected to the second coil 110 and a sensor (not shown) electrically connected to the controller 311. However, in the system 30, the jug 300 further includes a power storage device in the form of a supercapacitor (not shown) that can be charged (for example, when the accessory is not being used and is in an idle mode) and store power when power is received by the second coil 310 from the first coil 320. In further embodiments, a different type of power storage device may be used, for example, a battery.

Inclusion of the power storage device in the jug 300 allows the controller 311 and the associated sensor to be partially powered by the power stored in the power storage device, thereby eliminating the need for a strong power transmission link being maintained between the first and second coils 320, 310. With the power stored in the power storage device, the controller 311 of the jug 300 can rely on the stored power if insufficient power is being supplied by the first coil 320. This allows a longer range for operation of the system 30, i.e. a longer maximum operating distance between the jug 300 and the coffee machine, as the power storage device can provide the power required by the controller 311 and the associated sensor when the jug 300 is moved further away from the coffee machine. Moreover, the power storage device can be used to power a display on the jug 300, for example, an LCD display, to display the sensor data or other information to the user.

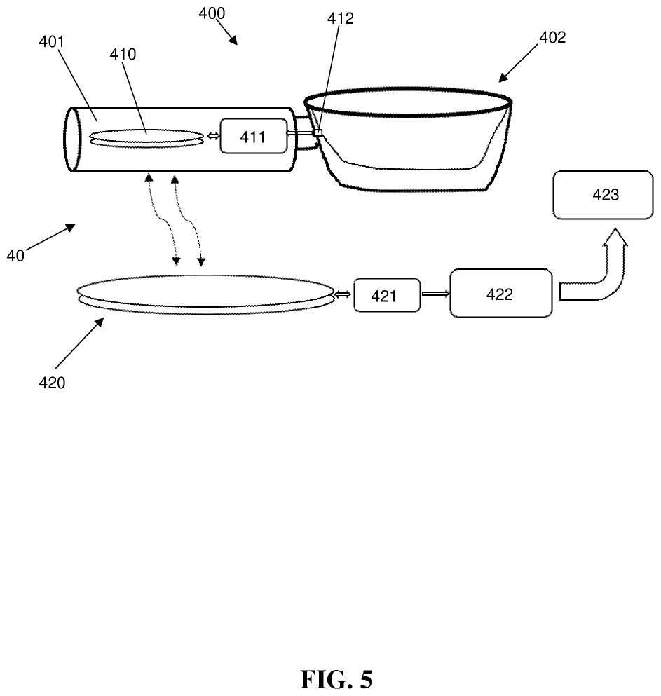

FIG. 5 illustrates a system 40 of powering and communicating with accessories, according to a further embodiment of the invention. The system 40 is similar to the system 20 but differences therebetween are noted below.

Like the system 20, the coffee machine of the system 40 includes a first coil 420, a first controller 221, a second controller 222 and a heater 423 electrically connected to each other. The portafilter 400 of the system 40 comprises a handle 401 and a basket portion 401, and includes a second coil 410, a controller 411 electrically connected to the second coil 410 and a sensor (not shown) electrically connected to the controller 411. However, in the system 40, the portafilter 400 further includes a power storage device in the form of a supercapacitor (not shown) that can be charged (for example, when the accessory is not being used and is in an idle mode) and store power when power is received by the second coil 410 from the first coil 420, similar to the power storage device of system 30. In further embodiments, a different type of power storage device may be used, for example, a battery or an ultracapacitor. The power storage device can be used to power a display on the portafilter 400, for example, an LCD display, to display the sensor data or other information to the user. In some embodiments, the power storage device can provide the required power to the portafilter 400 when it is in use (instead of receiving power from the first coil 420).

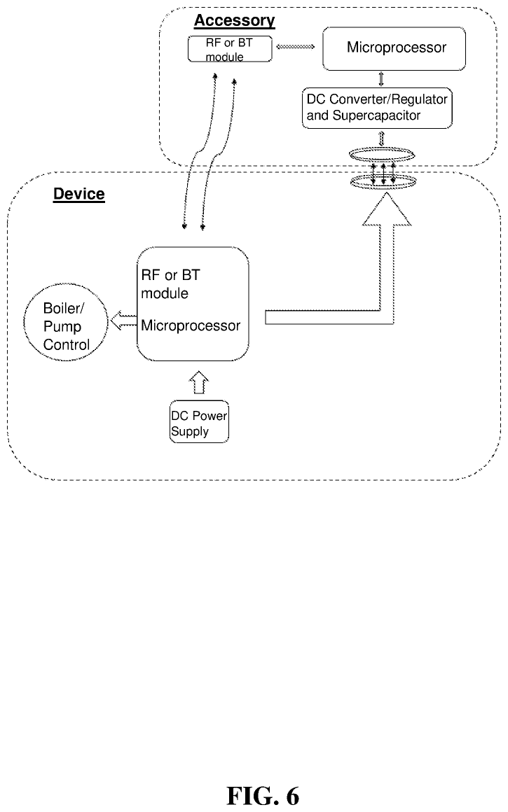

In some embodiments, the systems 30, 40 may include a radio frequency (RF) module, for example, a Bluetooth (BT) module, to transmit and/or receive the sensor data, as shown in FIG. 6. The RF module may be a low power RF module and the BT module may be a Bluetooth low energy (BLE) module. For example, as shown in FIG. 6, the RF module included in the accessory of the system 30, 40, and powered by the power received by the coil of the accessory, receives the sensor data from the microprocessor of the controller of the accessory and transmits the sensor data to the RF module located in the kitchen device. With the use of a RF module, data can be transmitted over a longer range and it also allows for sensor data to be transmitted from the RF module of the accessory to a mobile device of the user so that the user may collect the sensor data or control operation of the kitchen device accordingly.

Moreover, in some embodiments, the systems 20, 40 may include one or more light emitting diodes (LEDs) located in the portafilter 200, 400 (for example, in the handle 201, 401 and/or the basket portion 202, 402). The LEDs can be connected to the second coil 210, 410 without a controller, potentially requiring only a rectifier and/or a capacitor. Incorporation of the LEDs in the portafilter 200, 400 would provide aesthetic and functional benefits to the user.

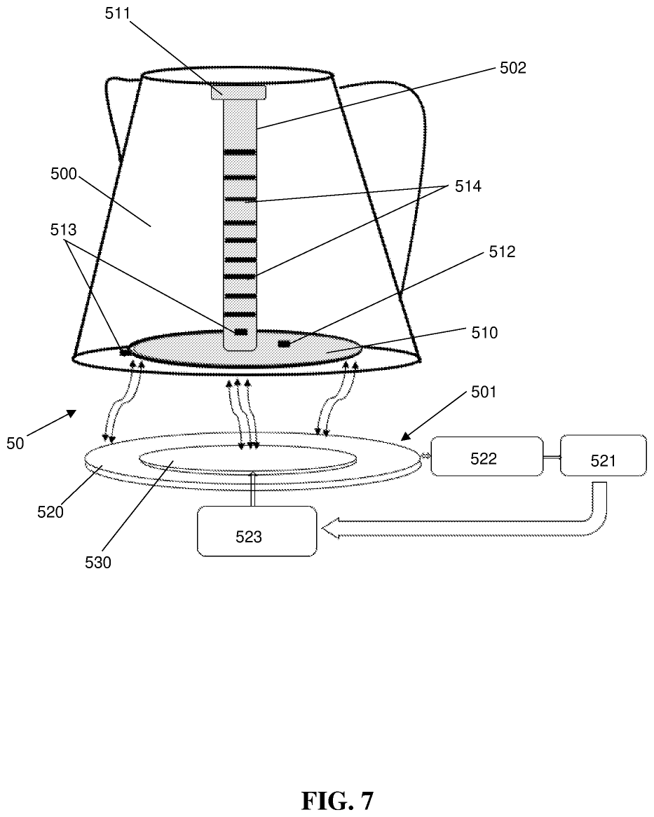

FIG. 7 illustrates a system 50 of powering and communicating with accessories, according to a further embodiment of the invention, implemented in an induction kettle. The system 50 is configured to allow a kitchen device to power and communicate with an accessory associated with the kitchen device. In this embodiment, the kitchen device comprises a heater base 501 and the accessory is a vessel 500 that holds the water or other liquid to be heated and rests on the heater base 501. The heater base 501 and the vessel 500 collectively function as the induction kettle.

The base 501 is connected to a power supply that is electrically coupled to an induction coil 530 housed within the base 501. The induction coil 530 is magnetically coupled to a heating element (not shown) located in the vessel 500 when the vessel 500 is resting on the base 501. In particular, the power supply is configured to deliver an alternating current to the induction coil 530, so that the induction coil 530 is operable to deliver a magnetic field to the heating element for heating water contained in the vessel 500. The heating element may be in the form of a heating disc or plate.

The base 501 further includes a first coil 520, a first controller 521, a power module 522 and a second controller 523 electrically connected to each other. The first coil 520 is configured to wirelessly power and communicate with a second coil 510 located in the vessel 500, for example by inducing electric current or electric potential in each other. The first controller 521 is configured to provide power and communicate with the first coil 520 and to also communicate with the second controller 523. In this embodiment, the second controller 523 is configured to control the induction coil 530 to heat the water in the vessel 500. However, in further embodiments, the second controller 122 may control other operation parameters of the induction kettle, for example, indicator lights, a display etc. Although the base 501 includes two coils—the induction coil 530 and first coil 502—the two coils are offset from each other and operate at different frequencies to minimize interference. However, in further embodiments, the base 501 may include only one coil that performs both functions and/or the two coils may operate at substantially the same frequency.

The vessel 500 includes the second coil 510 and a controller 511 electrically connected to the second coil 110. The second coil is located at a lower end of the vessel 500, adjacent the base 501 when the vessel 500 is located on the base 501, and the controller 511 is located at an opposite upper end of the vessel 500 to maintain a distance between the heating element and the controller 511. Appropriate separation is also maintained between the second coil 510 and the heating element in the vessel 500 to minimize radio interference and effects from the heat generated by the heating element. However, in the further embodiments, the controller 511 may be located elsewhere in the vessel 500. Located between the controller 511 and the second coil 510 is a shaft 502 that extends centrally through the vessel 500, i.e. the shaft 502 extends along a central axis of the cylindrical vessel 500. An upper end of the shaft 502 is connected to the controller 511 while the other lower end of the shaft 502 is connected to the second coil 510. However, in further embodiments, the shaft 502 may be located on and extend along a side wall of the vessel 500.

Several water level sensors 514 are located along the shaft 502, the water level sensors 514 being spaced from each other. The sensors 514 determine the height of the water level in the vessel 500 and transmit the data to the controller 511. However, in further embodiments, the shaft may include a plurality of sensors to measure another physical parameter or a physical parameter gradient. Locating the water level sensors 514 on the shaft 502 that extends centrally through the vessel 500 presents advantages over such sensors being located on a side wall of the vessel 500. By locating the sensors 514 in the center of the vessel 500, the sensors 514 do not need to be tilted (due to inclined side walls of the vessel 500) and can provide accurate readings of the water level. However, in further embodiments, the water level sensors 514 may be located elsewhere in the vessel 500 or other means or type of sensors may be used to accurately determine the water level in the vessel 500.

The water level sensors 514 also detect build up and/or presence of scale in the vessel 500 by comparing impedance between each sensor 514 that is immersed in water, which provides a relative difference in impedance and does not depend on the variation of impedance due to the type of water in the vessel 500. Generally, the sensor 514 closest to the heating element will be exposed to the highest temperature relative to sensors 514 located further away from the heating element, which results in faster scale build up on lower sensors 514 and slower scale build up in higher sensors 514. Thus, comparing the impedance level between sensors 514 and determining if it exceeds a predetermined threshold will indicate the scale build up status.

The vessel 500 also includes two temperature sensors 513, in the form of NTC thermistors, for measuring the temperature of the water in the vessel 500. One of these temperature sensors 513 is located at the lower end of the shaft 502 and the other temperature sensor 513 is located adjacent the second coil 510, both temperature sensors 513 being located at a distance from the heating element. However, in further embodiments, there may be only one or three or more temperature sensors 513 and/or the temperature sensors 513 may be located elsewhere in the vessel 500, for example, on a side wall of the vessel 500 or further along the shaft 502.

A further temperature sensor 512, in the form of a NTC thermistor, is embedded in or mounted on to the heating element to measure the temperature of the heating element. Embedding the temperature sensor 512 in the heating element minimizes response time and also minimizes any potential adverse effects from dirt or scale build up. In some embodiments, further sensors may be embedded in or mounted on to the heating element to detect and identify failure modes.

In some embodiments, the vessel 500 of the system 50 may include a power storage device in the form of a supercapacitor that can be charged (for example, when the vessel 500 is not being used) and store power when power is received by the second coil 510 from the first coil 520. This allows the data to be transferred to the base 501 when the vessel 500 is located at a distance from the base 501.

In use, when the vessel 500 is located on the base 501, the first coil 520 of the base 501 and the second coil 510 of the vessel 500 are inductively coupled and the second coil 510 receives electrical power from the first coil 520. Moreover, as noted above, the induction coil 530 and the heating element located in the vessel 500 are magnetically coupled and the heating element can be activated to heat water contained in the vessel 500.

The data from the temperature sensors 512, 513 and the water level sensors 513 is transmitted to the controller 511 and the data is then encoded and transmitted to the first coil 520 via the second coil 510. The power module 522 of the base 501 includes a data filter, in the form of an ASK filter, that decodes the data received by the first coil 520 and transmits the decoded data to the first controller 521. The first controller 521 uses the decoded data (i.e. temperature of water and/or heating element, water level etc.) and issues control commands to control operation of the induction coil 530 via the second controller 523. This allows for the desired water temperature to be reached and maintained accurately. The measured data is also used to implement a number of safety features, for example, detecting ‘dry-boiling’ (i.e. when there is no water in the vessel 500 of the kettle) and any faults in the temperature sensor.

In a further embodiment, the second coil 520 of the vessel 500 may receive power from the induction coil 530 in the base 501, and the transmitted power may be used to charge a power storage device in the form of a supercapacitor that can store power. Alternatively, the induction coil 530 may transmit power to or charge the power storage device by other means. The power storage device may power a radio frequency (RF) module (for example, a Bluetooth (BT) module) located in the vessel 500 to transmit and/or receive the sensor data from the base 501.

In a further embodiment, the system 30, system 40 or the system 50 may include an identifier located in the accessory, for example, a magnet, RFID, NFC tag etc., to allow the accessory (the jug 300, the portafilter 400 or the vessel 500) to be identified by the kitchen device (the coffee machine or the heater base 501). Each accessory has a unique identifier and the identifier can be powered by the power received by the second coil 310, 410, 510 from the first coil 320, 420, 520. In this manner, the coffee machine can identify the type of jug 100 or portafilter 200 or the heater base 501 can identify the vessel 500 being used and may alter its operation based on the accessory being used.

In some embodiments, the systems 10, 20, 50 may include a radio frequency (RF) module, for example, a Bluetooth (BT) module, to transmit and/or receive the sensor data. The RF module may be a low power RF module and the BT module may be a Bluetooth low energy (BLE) module. For example, the RF module included in the accessory of the system 10, 20, 50 and powered by the power received by the coil of the accessory, receives the sensor data from the microprocessor of the controller of the accessory and transmits the sensor data to the RF module located in the kitchen device. With the use of a RF module, data can be transmitted over a longer range and it also allows for sensor data to be transmitted from the RF module of the accessory to a mobile device of the user so that the user may collect the sensor data or control operation of the kitchen device accordingly.

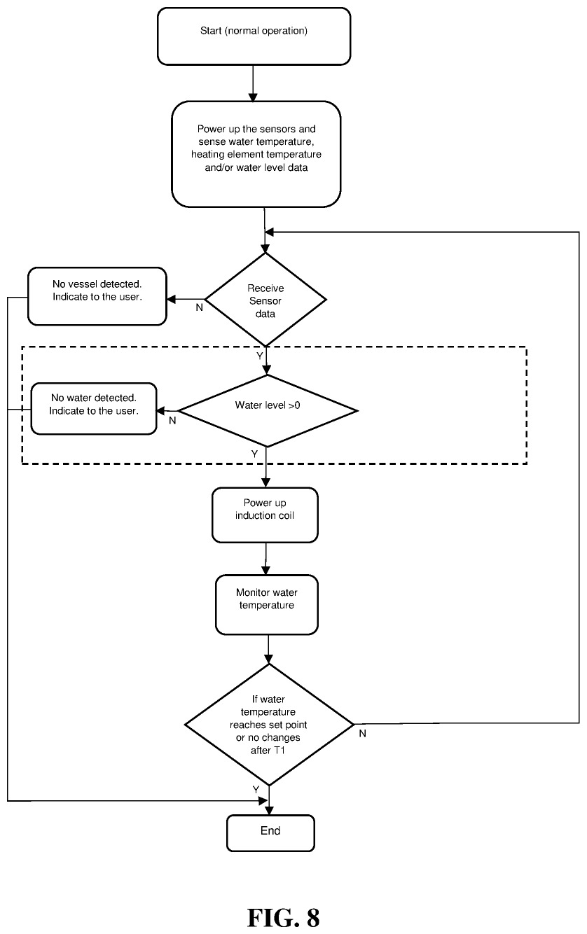

FIG. 8 illustrates ‘normal’ operation of the induction kettle shown in FIG. 7. When the kettle is switched on, the sensors are powered up and start transmitting the data relating to the water temperature, heating element temperature and the water level to the controller 521 in the base 501. If no sensor data is received by the base 501, this would indicate that the vessel 500 is not located on the base 501 and the kettle does not perform any further functions such as powering up the induction coil 530. Similarly, if the sensor data indicates that there is no water in the vessel 500, no further functions are performed by the kettle. However, if the sensor data is received by the base 501 and the water level indicates that the vessel 500 does contain water, the induction coil 530 is powered up and heating of the water is initiated. As the water is being heated, the temperature of the water is monitored by the temperature sensors 513 to check if the water temperature has reached the desired temperature set by the user or if there are no changes in the temperature of the water beyond a pre-determined temperature. If either of these conditions are satisfied, the kettle powers down and no further functions are performed by the kettle.

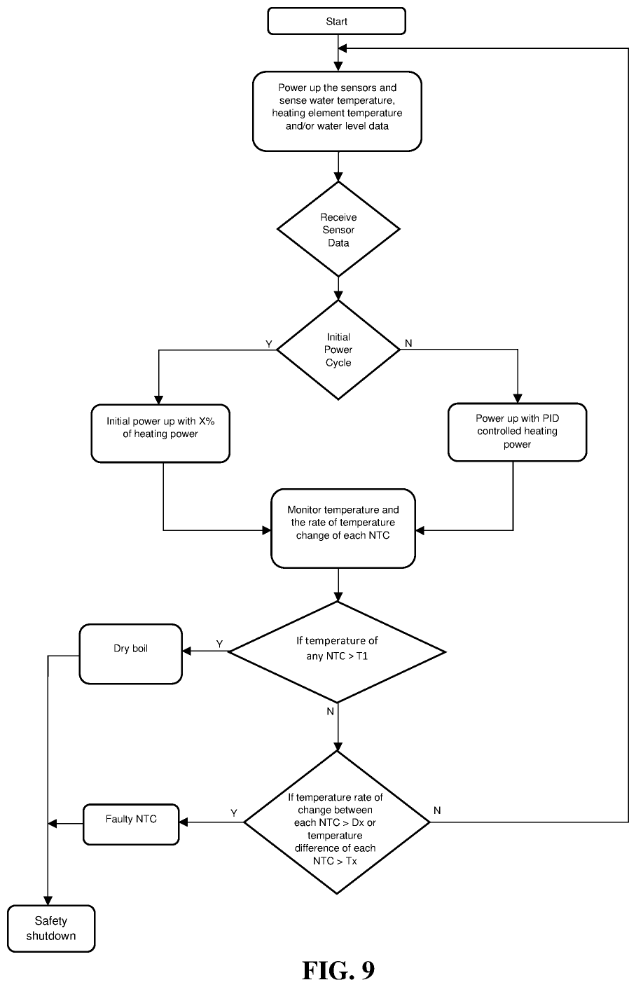

FIG. 9 illustrates a safety logic for detecting abnormal conditions during operation of the induction kettle shown in FIG. 7. This safety logic allows for detection of ‘dry boil’ and faults in the temperature sensor. Initially, the sensors are powered up and start transmitting the data relating to the water temperature, heating element temperature and the water level to the controller 521 in the base 501. Next, it is determined if an initial power cycle, i.e. the first power cycle that is initiated when the kettle is powered up, has been completed. If the initial power cycle has not been performed, the induction coil 530 is powered up with a predetermined amount of the total power available for the induction coil 530 and the temperature and rate of change of temperature of each temperature sensor is monitored. However, if the initial power cycle has been previously performed, the induction coil 530 is powered up with the power available for heating, with the power supplied to the induction coil 530 being controlled with a PID controller, and the temperature and rate of change of temperature of each temperature sensor is monitored.

The data received from the sensors located in the vessel 500 of the kettle is monitored to check if ‘dry boil’ conditions are present or if any of the temperature sensors are faulty. In particular, if the temperature of any of the temperature sensors exceeds a cut-off temperature T₁, it is determined that ‘dry boil’ conditions are present and a safety shutdown of the kettle is performed. The cut-off temperature T₁ is calculated as per the following formula:

$${T}_{1} = C - ( a * ( \frac{d T}{d t} ) ) - ( b * {T}_{s} )$$

where C is the maximum cut-off temperature, dT/dt is the rate of change of temperature of the heating element, Tₛ is the initial temperature of the heating element prior to being heated and ‘a’ and ‘b’ are predetermined constants that are calculated based on various factors such as heating capacity/power of the kettle and physical design of the kettle (i.e. water capacity, material etc.). In further embodiments, dT/dt may be the rate of change of temperature of the water, and Tₛ may be the initial temperature of the water prior to being heated.

Alternatively, if the difference in the rate of change in temperature of two successive or adjacent temperature sensors exceeds a first predetermined limit Dₓ, or if the difference in temperature of two successive or adjacent temperature sensors exceeds a second predetermined limit Tx, it is determined that at least one of the temperature sensors is faulty and a safety shutdown of the kettle is performed. In this manner, the data obtained from the sensors located in the vessel 500 of the kettle can be used to implement various safety features during operation of the kettle.

In this specification, adjectives such as first and second, forward and backward, upward and downward, top and bottom, proximal and distal, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above-described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A system configured to allow a kitchen device to power and communicate with an associated accessory, the system comprising:
a first coil located in the kitchen device;
a second coil, at least one sensor and a controller located in the accessory, the at least one sensor and controller being connected to the second coil,
wherein, when the first and second coils are inductively coupled, the controller is configured to:
receive data from the at least one sensor, the data relating to a physical attribute, and
transmit the data to the first coil via the second coil, and
wherein the second coil is configured to receive electrical power from the first coil.

2. The system of claim 1, wherein the first coil is located in a portion of the kitchen device that is adjacent a region where the accessory is likely to be used.

3. The system of claim 1 or 2, wherein the kitchen device includes a first controller electrically connected to the first coil, the first controller being configured to provide power to and communicate with the first coil.

4. The system of claim 3, wherein the kitchen device includes a second controller electrically connected to the first controller and the first coil.

5. The system of claim 4, wherein the second controller is configured to:
control temperature and flow rate of steam emitted through an aerating member of the kitchen device, or
control temperature and flow rate of water being used to extract coffee, or
control an induction coil of the kitchen device to heat the water in the accessory.

6. The system of any one of the preceding claims, wherein the at least one sensor is configured to measure a physical attribute of fluid in the accessory.

7. The system of claim 7, wherein the physical attribute is temperature, density and/or turbidity of the fluid.

8. The system of any one of the preceding claims, wherein the data is encoded by the controller of the accessory prior to being transmitted to the first coil and the encoded data is decoded by the first controller of the kitchen device.

9. The system of any one of the preceding claims, wherein:
the second coil and the controller of the accessory are attached to a bottom wall of the accessory, or
the second coil and the controller of the accessory are housed in a handle of the accessory, or
the second coil is located at a lower end of the accessory and the controller of the accessory is located at an opposite upper end of the accessory.

10. The system of any one of the preceding claims, wherein the accessory includes an identifier located therein, the identifier configured to allow the accessory to be identified by the kitchen device.

11. The system of claim 10, wherein the identifier is configured to be powered by the electrical power received by the second coil from the first coil.

12. The system of any one of the preceding claims, wherein the accessory includes a power storage device that is configured to store power when the electrical power is received by the second coil from the first coil.

13. The system of claim 12, wherein the power storage device allows the controller of the accessory and the at least one sensor to be powered by the power stored in the power storage device.

14. The system of claim 12 or 13, wherein the power storage device is a supercapacitor or a battery.

15. The system of any one of the preceding claims, wherein the system includes a radio frequency (RF) or Bluetooth (BT) module to transmit and/or receive the data from the at least one sensor.

16. The system of any one of claims 1-15, wherein the kitchen device is a coffee machine and the accessory is a fluid container or jug.

17. The system of any one of claims 1-15, wherein the kitchen device is a coffee machine and the accessory is a portafilter for use with the coffee machine.

18. The system of any one of claims 1-15, wherein the accessory is a vessel and the kitchen device is a heater base associated with the vessel, the vessel and the base collectively functioning as an induction kettle.

19. The system of claim 18, wherein an induction coil of the kitchen device is magnetically coupled to a heating element located in the accessory, when the accessory is resting on the kitchen device, to heat water contained in the accessory.

20. The system of claim 18 or 19, wherein a shaft extends centrally through the accessory, the shaft including a plurality of sensors.

21. The system of claim 20, wherein the plurality of sensors determine a height of water level of the water in the accessory.

22. A kitchen device configured to power and communicate with an associated accessory, the kitchen device comprising:
a first coil configured to be inductively coupled with a second coil located in the accessory and to transmit electrical power to the second coil,
wherein, when the first and second coils are inductively coupled, the first coil is configured to receive data from at least one sensor located in the accessory via the second coil, the data relating to a physical attribute.

23. An accessory configured to be powered by and communicate with an associated kitchen device, the accessory comprising:
a second coil, at least one sensor and a controller located in the accessory, the at least one sensor and controller being connected to the second coil,
wherein the second coil is configured to receive electrical power from a first coil located in the kitchen device, and
wherein, when the first and second coils are inductively coupled, the controller is configured to:
receive data from the at least one sensor, the data relating to a physical attribute, and
transmit the data to the first coil via the second coil.

24. A method of powering and communicating with an accessory associated with a kitchen device, the method comprising:
locating a second coil of the accessory adjacent a first coil of the kitchen device to inductively couple the first and second coils;
transmitting electrical power from the first coil to the second coil;
receiving, by a controller of the accessory, data from at least one sensor located in the accessory, the data relating to a physical attribute;
transmitting, by the controller, the data to the first coil via the second coil.

25. The method of claim 24, wherein transmitting electrical power from the first coil to the second coil includes:
generating, by the first coil, a signal at a predetermined frequency;
generating, by the second coil, the electrical power from the signal.

26. The method of claim 24, wherein transmitting, by the controller, the data to the first coil via the second coil includes:
encoding, by the controller, the data from the at least one sensor;
transmitting the encoded data to the first coil;
decoding, by a first controller of the kitchen device, the encoded data.

27. A method of operating a kitchen device and an associated accessory, the method comprising:
locating the accessory adjacent the kitchen device to inductively couple a first coil of the kitchen device and a second coil of the accessory;
transmitting, to the first coil via the second coil, data from at least one sensor located in the accessory, the data relating to a physical attribute;
determining a water level in the accessory and, when the data indicates that there is no water in the accessory, powering down the kitchen device, or, when the data indicates that the accessory contains water, heating the water by powering up an induction coil of the kitchen device.

28. The method of claim 27, wherein the method further includes:
monitoring a temperature of the water by the at least one sensor;
powering down the kitchen device if the temperature of the water has reached a temperature set by a user or if there is no change in the temperature of the water beyond a pre-determined temperature.

29. The method of any one of claim 27 or 28, wherein method further includes detecting “dry boil” by determining when a temperature sensed by the at least sensor is greater than a cut-off temperature and powering down the kitchen device.

30. The method of claim 27-29, wherein the cut-off temperature T₁ is calculated as per the following formula:
$${T}_{1} = C - ( a * ( \frac{d T}{d t} ) ) - ( b * {T}_{s} )$$
where C is the maximum cut-off temperature for the accessory, dT/dt is a rate of change of temperature of the heating element, Tₛ is an initial temperature of the heating element prior to being heated and ‘a’ and ‘b’ are predetermined constants.

31. The method of any one of claims 27-30, wherein method further includes:
when a difference in a rate of change in temperature of two adjacent sensors of the at least one sensor exceeds a first predetermined limit or if a difference in temperature of the two adjacent sensors exceeds a second predetermined limit, determining that one of the two adjacent sensors is faulty and powering down the kitchen device.
